(19) United States
(12) Patent Application Publication
(10) Pub. No.: US 2004/0231910 A1
(43) Pub. Date: Nov. 25, 2004

(54) Vehicle with articulated drive sprocket

(76) Inventors: Daniel Mercier, Longuevil, CA (US); Mathlau Audet, Montreal, CA (US)

Correspondence Address: BOMBARDIER RECREATIONAL PRODUCTS INC, INTELLECTUAL PROPERTY DEPT, PO BOX 230, NORTON, VT, 05907-0230, US

(21) Appl. No.: 10/771,372

(22) Filed: Feb. 5, 2004

Related U.S. Application Data
(60) Provisional application No. 60/444,959, filed on Feb. 5, 2003.

(51) Int. Cl. B60K 17/02

(52) U.S. Cl. 180/383

(57) ABSTRACT

A drive system for a vehicle is described having a rubber mounted engine that provides a co-planar drive sprocket and driven sprocket. An articulated link located in the drive train between the engine and the drive sprocket allows independent movement of the engine with respect to the drive sprocket. The drive sprocket is rotationally held either by the frame member or the swing arm member.

### CROSS REFERENCE TO RELATED APPLICATIONS

This application relies for priority on U.S. Provisional Patent Application Ser. No. 60/444,959, which was filed on Feb. 5, 2003, the contents of which are incorporated herein by reference.

### FIELD OF THE INVENTION

This invention is related to a vehicle drive system. More particularly, the invention relates to various embodiments for an articulated drive sprocket for a vehicle's drive train.

### BACKGROUND OF THE INVENTION

Drive systems in vehicles are used to transfer power from the energy source to drive mechanisms to affect movement. In a vehicle, the energy source typically is an engine, and the drive mechanism typically includes wheels that transfer power into motion so that the vehicle will move. Many different drive systems can connect between the engine and the wheels to transfer the power. For example, chains, belts and drive shafts can be used.

Typically, the engine is mounted on the vehicle frame. However, a rigid connection between the engine and the vehicle's frame raises several problems. With a rigid mount, engine vibration is transmitted directly to the frame. Vibrations transmitted to the frame can generate noise and create other problems. In vehicle design, noise reduction is an important issue and vehicle engineers strive to limit vibration propagation outside of the engine.

One way to address engine vibration is to rubber mount an engine on a frame, which is well known as disclosed in U.S. Pat. Nos. 4,323,135 and 4,465,157 and in Patent Abstract of Japan No. 3288035. By this, the vibration transmission to the frame is limited by the rubber damping effect. Many automobiles use rubber mounts to hold the engine on the chassis.

In vehicle design, the mechanism by which power is transferred from the engine to the wheels differs from vehicle to vehicle. In the case of automobiles, one or more drive shafts connect the engine to the wheels. Various drive shafts limits the forces acting on the engine during operation because only torque is experienced by the engine. Moreover, to limit the propagation of vibration from the engine to the chassis, both the engine and the drive shafts for automobiles typically are rubber-mounted to the chassis.

Other vehicles use belts and chains to transfer motion power to the wheel(s) and usually have their engines directly connected to the frame. This also means the rigid casing of the engine may be connected to the frame using several, rigid brackets. The engine casing can also be utilized as a structural member and can act as part of the frame structure. The stiffness of this engine-frame layout prevents any relative movement between the engine and the frame. This allows the engine to transmit power to the wheel while limiting the complexity of the drive system.

When a vehicle has a suspension assembly, the only relative movement between the engine and the wheel is the drive wheel travel, which is defined by the suspension geometry. Systems that are suitable to transmit power between the engine and the wheel are, in that respect, well known in the art.

A vehicle using a belt or a chain, instead of a drive shaft, for transmitting power from the engine to the wheel(s) must overcome at least one distinct problem. The engine is subjected to torque and additional forces because of the very nature of the chain or belt drive system. A first torque will be experienced by the engine that is generated by the resistance applied to the sprocket on the output shaft of the engine. This is illustrated in FIG. 22a. This torque is the same as the one experienced by a drive shaft system. It tends to twist the engine on its horizontal axis. A force is also imposed on the engine by pulling effect of the chain or the belt. This force generates a second torque as shown in FIG. 22b. For instance, on a motorcycle, this force pulls on the side of the engine on which the sprocket is positioned in a direction toward the user end of the vehicle. This force tends to twist the engine on its vertical axis as illustrated in FIG. 22b. The second torque, then, has a different effect than the first torque. The second torque does not exist in a system using a drive shaft.

The effect that the first torque and the second torque have on the engine is not co-planar. The effect of the second torque would be co-planar if the drive sprocket were mounted in the center of the transversal axis of the engine as shown in FIG. 22c, but this is rarely the case. Design requirements typically result in the drive sprocket being positioned on one side of the engine. This positioning of the sprocket on the side of the engine causes the engine to experience the second torque. These two torques have generally little effect on the position of the engine in the frame as long as the engine is rigidly mounted. However, where rubber mounts are used between the engine and the frame, the engine, when subjected to these torques, will move in relation to the frame.

A problem occurs when a chain or a belt is used in a drive system because the drive sprocket is fixed to the engine. As described above, with a resilient mount, the engine moves, which causes the drive sprocket to move accordingly. However, the driven sprocket associated with the vehicle's wheel does not move. As a result, the two sprockets do not remain in the same plane. Chain and belt drive systems can accommodate small variations between the drive sprocket and the driven sprocket. They are, however, not designed to accommodate more than small variations and as a result, can be subject to misalignment that affects their performance and their useful lives.

As would be recognized by one of ordinary skill in the art of vehicle design, a drive system on a vehicle having a suspension assembly is more complex than the drive system on a vehicle that does not have a suspension assembly. Because the suspension assembly moves the wheels with respect to the frame, the distance between the driven wheel and the engine changes. It is, therefore, desirable to have the drive system spacing adjust accordingly.

As indicated above, it is especially desirable to be able to construct a drive system on a vehicle with a suspension assembly where the vehicle incorporates a resilient engine-frame assembly. The prior art, however, provides no guidance as to how such a drive system should be constructed.

### SUMMARY OF THE INVENTION

Accordingly, one aspect of embodiments of this invention provides a drive system for a vehicle with a resiliently-mounted engine where a drive sprocket is maintained co-planar with the driven sprocket.

It is another aspect of embodiments of this invention to provide a constant distance between the drive sprocket and the driven sprocket on a vehicle having a suspension assembly.

One other aspect of this invention provides a resilient member between the engine and the drive system to reduce vibration generated by rotational articulation therebetween.

Aspects of this invention are attained by the use of an articulated member between the engine and the drive sprocket. The drive sprocket location can be maintained by a connection to the frame of the vehicle or to the suspension element that also holds the driven sprocket. The latter also provides a constant distance between the drive and the driven sprockets, although the suspension moves during operation of the vehicle.

In accordance with the present invention, one aspect is to provide a vehicle with a frame and an engine resiliently attached to the frame, generating power. The vehicle also includes a power output member operatively connected to the engine, at least one front wheel attached to the frame, at least one rear wheel attached the frame, and a handle bar operatively connected to the frame, permitting steering of at least one of the front and rear wheels. The vehicle also has a straddle seat supported by the frame, a power transmitting device operatively connected between the power output member and at least one of the front and rear wheels to transmit the power thereto from the engine, and a link operatively coupled between the power output member and the power transmitting device, the link transmitting the power from the power output member to the power transmitting device such that at least one of angular or axial misalignment between the power output member and the power transmitting device is tolerated.

In accordance with the present invention, one further aspect is to provide a vehicle with a frame and an engine resiliently attached to the frame, generating power. The engine has a power output member operatively connected thereto. At least one front wheel is attached to the frame and at least one rear wheel is attached to the frame. A handle bar is operatively connected to the frame, permitting steering of at least one of the front and rear wheels. The vehicle also has a straddle seat supported by the frame. A power transmitting device is operatively connected between the power output member and at least one of the front and rear wheels to transmit the power thereto from the engine. In addition, the vehicle includes means for accommodating non rotational movement of the power transmitting device with respect to the output member and for transmitting rotational movement from the output member to the power transmitting device.

In accordance with the present invention, an additional aspect is to provide a vehicle with a frame and an engine resiliently mounted to the frame allowing relative movement of the engine with respect to the frame and attenuating transmission of engine vibrations to the frame. The engine has a power output member. The vehicle includes a straddle seat supported by the frame, at least one front wheel connected to the frame, at least one rear wheel connected to the frame, and a handle bar operatively connected to the frame, permitting steering of at least one of the front and rear wheels. A drive member is rotatably mounted to the frame. The drive member is constructed and arranged to receive power from the power output member. The vehicle also includes a shaft having a first end and a second end, the first end being connected to the power output member, the second end being connected to the drive member, wherein the shaft accommodates non rotational movement of the output member with respect to the drive member while transmitting rotational movement of the output member from the drive member.

Other advantages and salient features of the invention will become apparent from the following detailed description, which, taken in conjunction with the annexed drawings, disclosed preferred embodiments of the invention.

### BRIEF DESCRIPTION OF THE DRAWINGS

Referring now to the drawings which from a part of this original disclosure:

FIG. 1a is a top view of a prior art drive system;

FIG. 1b is a top view of a prior art rubber type junction between two shafts;

FIG. 1c is a top view of a prior art “spring type” junction between two shafts;

FIG. 1d is an exploded view of a prior art double rubber disc-type junction between two shafts;

FIG. 2a is a top view of a portion of a prior art spline shaft;

FIG. 2b is a partial, cross-sectional view of a prior art constant radius spline;

FIG. 2c is a partial, cross-sectional view of a prior art multiple radius spline;

FIG. 3a is a top view of a layout for a connector disposed between two male spline shafts disposed at an angle to one another;

FIG. 3b is a top view of a schematic showing the maximum angular displacement for a connector disposed on a single male spline shaft;

FIG. 4 is a top view of a schematic showing a connector extending between two male splines that are offset from one another;

FIG. 5a is a top view of a spline male junction;

FIG. 5b is a top view of a spline female junction;

FIG. 6 is a schematic top view of a rubber mounted engine layout for a vehicle that relies on a belt to transfer power from the engine to one of the vehicle's wheels;

FIG. 7 is a schematic top view of a rubber mounted engine layout for a vehicle that relies on a chain to transfer power from the engine to one of the vehicle's wheels;

FIG. 8 is a schematic top view of a rubber mounted-engine layout for a vehicle that relies on a drive shaft to transfer power from the engine to one of the vehicle's wheels;

FIG. 9 is a schematic side view of the effect on a front and a rear sprocket of the movement of an associated suspension when the drive sprocket is held fixedly on the vehicle's frame;

FIG. 10 is a schematic side view of the effect on a front and rear sprocket when the front and rear sprockets are both connected to a swing arm;

FIG. 11 is a schematic top view of a two wheeled vehicle;

FIG. 12 is a schematic top view of a three wheeled vehicle with one wheel in front;

FIG. 13 is a schematic top view of a three wheeled vehicle with one wheel at the rear;

FIG. 14 is a schematic top view of a four wheeled vehicle;

FIG. 15a is a schematic side view of a vehicle having a suspension;

FIG. 15b is a schematic side view of a vehicle without a suspension;

FIG. 16 is a cross-sectional view of one embodiment of the articulated link and drive sprocket according to the invention;

FIG. 17 is a perspective view of an assembled articulated link and drive sprocket of the type shown in FIG. 16;

FIG. 18 is another perspective view of the assembled articulated link and drive sprocket shown in FIG. 17, taken from a different vantage point;

FIG. 19 is an exploded, perspective view of the articulated link and drive sprocket shown in FIGS. 17 and 18;

FIG. 20 is another exploded, perspective view of the articulated link and drive sprocket shown in FIG. 19, taken from a different perspective;

FIG. 21(a) is a schematic of a drive sprocket single shear arrangement;

FIG. 21(b) is a schematic of a drive sprocket double shear arrangement;

FIG. 22(a) illustrates schematically a first torque applied to an engine during operation;

FIG. 22(b) illustrates schematically a second torque applied to an engine during operation when a drive belt or chain transmits motive power to one of the wheels on a vehicle;

FIG. 22(c) illustrates schematically an engine design that relies on a belt or chain to transmit power to a vehicle's wheels, except that the engine experiences only the first torque shown in FIG. 22(a);

FIG. 23 is a partial cross-sectional view of one spline male articulation constructed to the teachings of the present invention; and

FIG. 24 is a partial cross-sectional view of one spline female articulation constructed according to the teachings of the present invention.

### DESCRIPTION OF THE EMBODIMENTS OF THE INVENTION

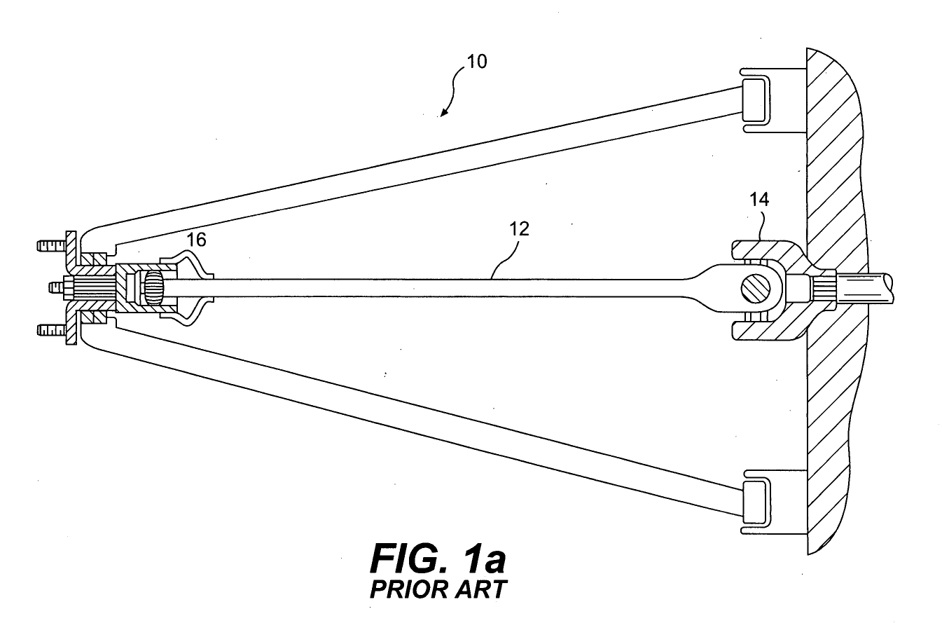

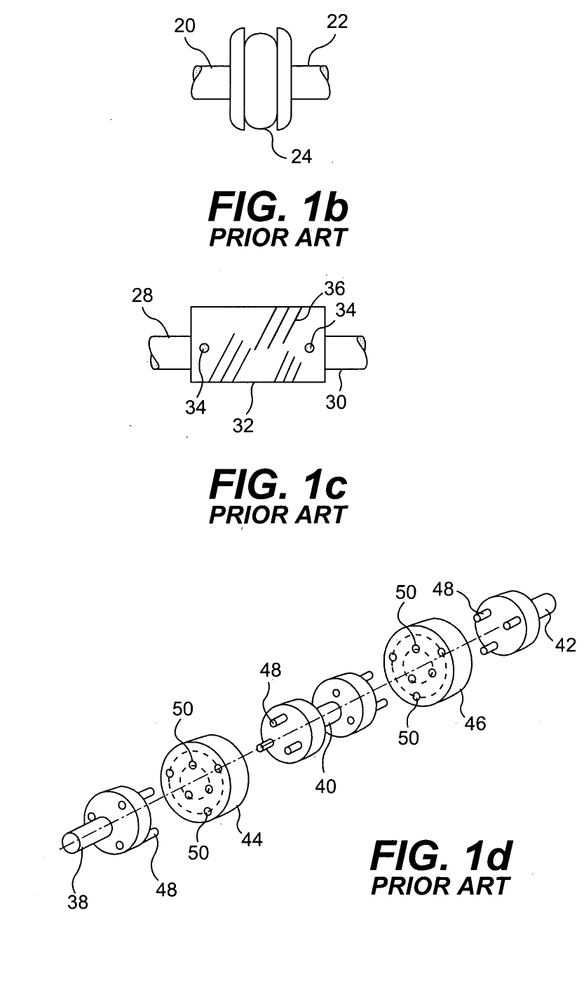

FIG. 1a illustrates a top view of a classic “A” arm 10 utilized on a vehicle suspension having an articulated drive axle 12. Universal joint 14 and spline joint 16 provide the necessary articulation needed by the drive axle 12 to follow the movements of the “A” arm 10. This type of arrangement has been used to provide motive power to a wheel suspended on the A arm 10, such as may be found on automobiles, for example. The arrangement illustrates a first example of a flexible type joint, the universal joint 14.

FIG. 1b presents an alternative flexible type joint known in the prior art. The first axle part 20 is connected to the second axle part 22 using a rubber section 24 which is affixed, by a suitable adhesive, between the first and second axle parts 20, 22. The rubber section 24 permits the first and second axle parts 20, 22 to angularly shift with respect to one another without impeding the transfer of power therebetween.

FIG. 1c shows another flexible joint known in the prior art. It is composed of a first axle part 28, a second axle part 30 and a metallic spring-like part 32 that links the first axle part 28 to the second axle part 30. The metallic, spring like part 32 connects the axle parts 28, 30 using a locking mechanism such as a dowel pin 34. The metallic, spring-like part 32 is usually has a hollow, cylindrical shape. As is known to those skilled in the art, the metallic, spring-like part 32 is manufactured by machining a cylindrical tube to remove material 36, thereby creating a flexible connector. While the spring-like part may take any of a number of shapes and configurations as would be appreciated by those skilled in the art, one known embodiment is manufactured and sold under the trademark Heli-Cal® by Helical Products Company, Inc. (see www.heli-cal.com).

FIG. 1d illustrates a fourth flexible joint known in the prior art. The joint has a first axle part 38, an intermediate axle part 40 and a second axle part 42. The first axle part 38 is connected to the intermediate axle part 40 by a rubber part 44. The same type of junction is utilized between the intermediate axle part 40 and the second axle part 42 using rubber part 46. A stud 48 and hole 50 pattern is used to connect the various parts together.

As shown in FIGS. 1a-1d, it is known to use a flexible connector to transmit energy from one rotating element to another. This assures that, even if the two rotating parts should change their angular relationship with respect to one another (even if only momentarily), rotational energy will be transmitted from one part to the other without damage to the rotating elements.

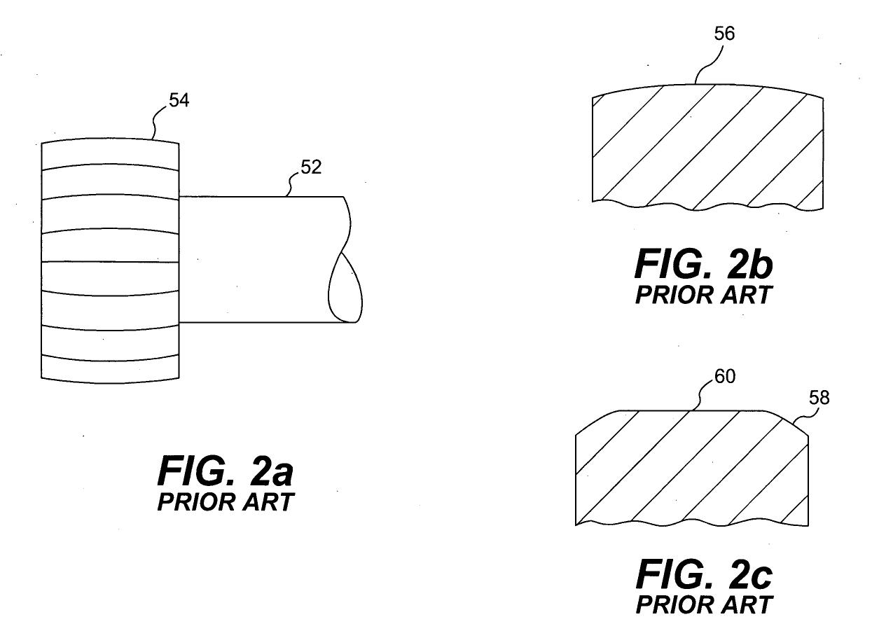

Spline connections between two rotating shafts are also known in the art. Spline connections also permit angular deviation between shafts without a loss of transmission of rotational energy. FIG. 2a shows a shaft 52 that has a spline 54 at its end. The spline 54 is of a type known in the prior art. As would be appreciated by those skilled in the art, the spline 54 has a grooved, outer surface constructed to engage a grooved, inner surface of the female end of another drive shaft or a connector.

FIG. 2b provides a profile of the spline 54 with a standard spline radius 56. As illustration shows, the surface of the spline 54 is slightly curved to accommodate angular displacement of the spline 54 during operation. The curve is constant across the spline. A spline so constructed, therefore, is often referred to an a single radius spline. The angular displacement may be due to vibrations experience by the spline 54 when rotating.

FIG. 2c presents an alternate spline profile that has a flat section 60. The spline also includes two curved section 58 disposed on either side of the flat section 60. This spline, often referred to as a multiple radius spline, is also of a type known in the prior art.

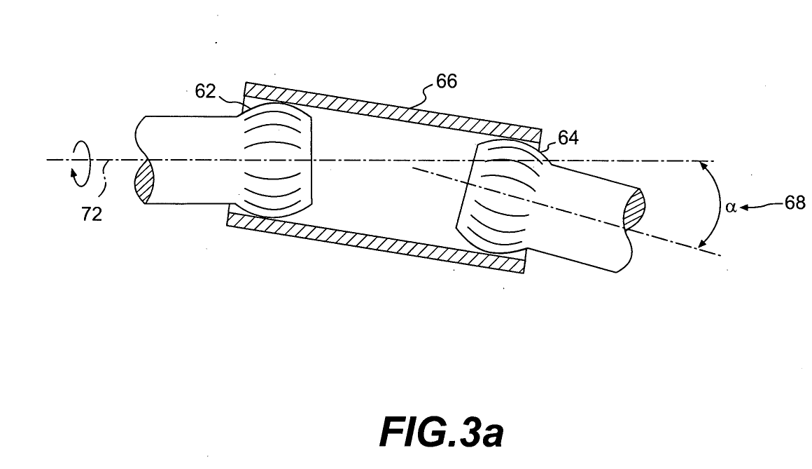

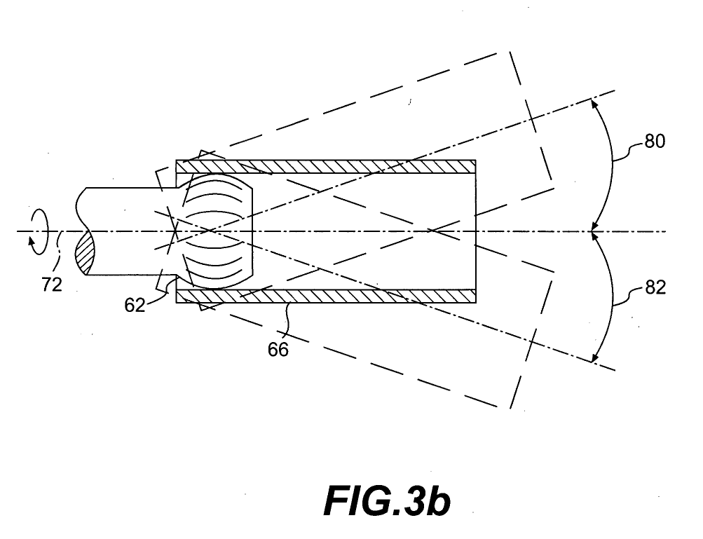

FIG. 3a illustrates a typical double spline assembly known in the prior art. The first male spline 62 is connected to the second male spline 64 using a female junction member 66. As shown, the first male spline 62 is not co-axial with the second male spline 64. Instead, the first male spline 62 is offset from the second male spline 64 by a power transmission angle 68.

As indicated in FIG. 3b, there is an angular limit that the spline connection may provide. FIG. 3b shows the angular limits 80 and 82, on each side of the spline axis 72. In other words, the power transmission angle 68 may not exceed the angular limits 80, 82. If the angular limits 80, 82 are exceeded, there is the possibility that one or more of the splines 62, 64 or the female junction member 66 may be permanently deformed or damaged, thereby hindering or preventing the transmission of rotational motion.

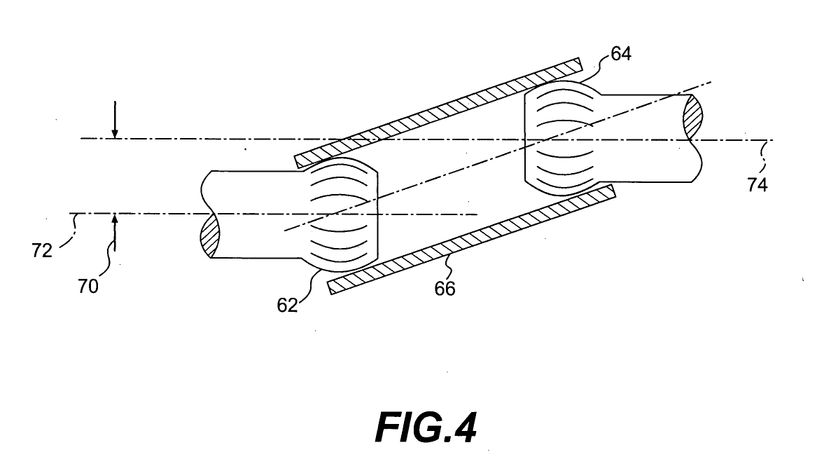

FIG. 4 presents the same spline assembly as in FIGS. 3a and 3b. Here, a lateral misalignment is shown. The first spline 62 axis 72 is not coaxial with the second spline 64 axis 74 although the two axes 72, 74 are parallel. The distance 70 represents the misalignment distance between the two different axes 72, 74. As indicated above, this type of arrangement may tolerate misalignment, but only to the extent that the angular limits 80, 82 are not exceeded.

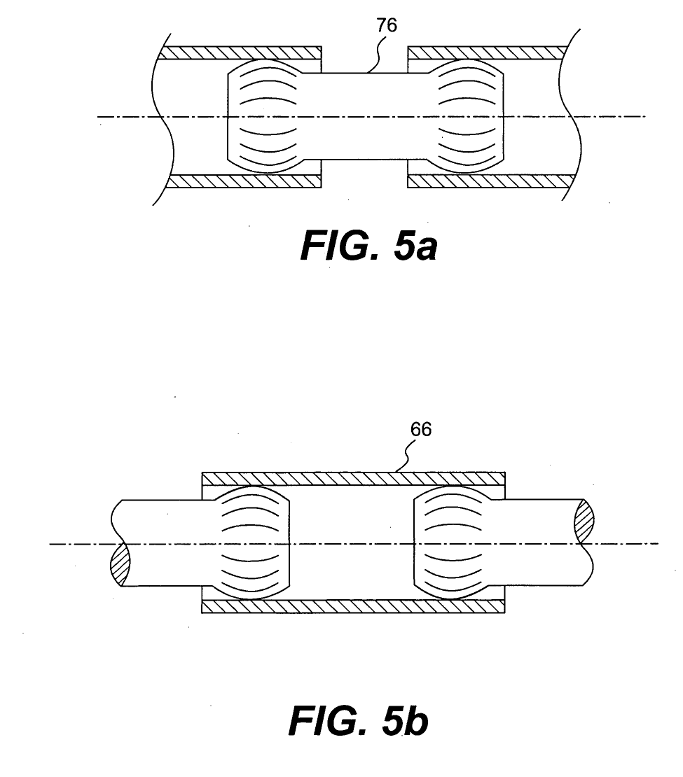

FIGS. 5a and 5b illustrate a male-type junction member 76 and a female-type junction member 66 respectively. As may be appreciated from the two drawings, both types of junction members 76, 66 effectively transmit rotational power from one drive shaft to another.

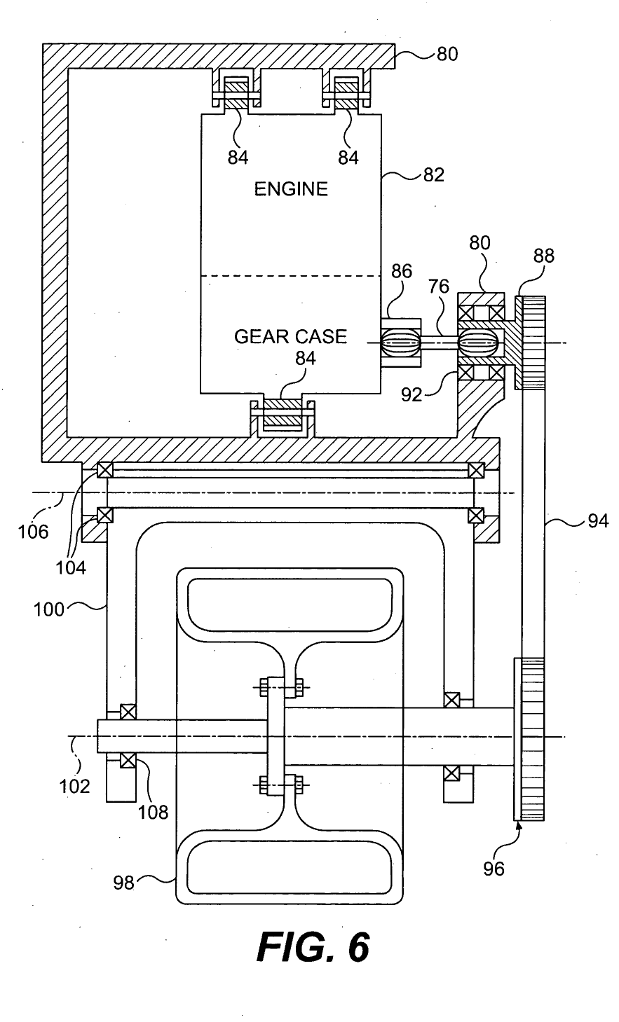

FIG. 6 presents a schematic vehicle layout with a frame 80, an engine and transmission assembly 82 and rubber mounts 84 that connect the engine and transmission assembly 82 to the frame 80. A power output member 86 is rotatably connected to the engine and transmission assembly 82. In the embodiment illustrated, the power output member 86 includes a female portion. One end of a double spline male member connector 76 is disposed within the female portion of the power output member 86. The other end of the double spline male member connector 76 mates with a female portion of a drive sprocket 88, which is disposed on the frame 80. A bearing 92 permits the sprocket 88 to rotate relative to the frame 80. A longitudinal, power transmitting device 94, such as a belt, is operatively connected between the drive sprocket 88 and the driven sprocket 96. Since the drive sprocket 88 is fixed on the frame 80 by bearing 92, the drive sprocket 88 does not pivot with respect to the frame 80. Instead, the drive sprocket 88 is only permitted to rotate with respect to the frame 80 and, for this reason is said to resist translational movement with respect to the frame. Moreover, the drive sprocket 88 is not permitted to move laterally. With this construction, the drive sprocket 88 is maintained in the same plane as the drive sprocket 96. In the illustrated embodiment, the longitudinal power-transmitting device 94 is a belt drive.

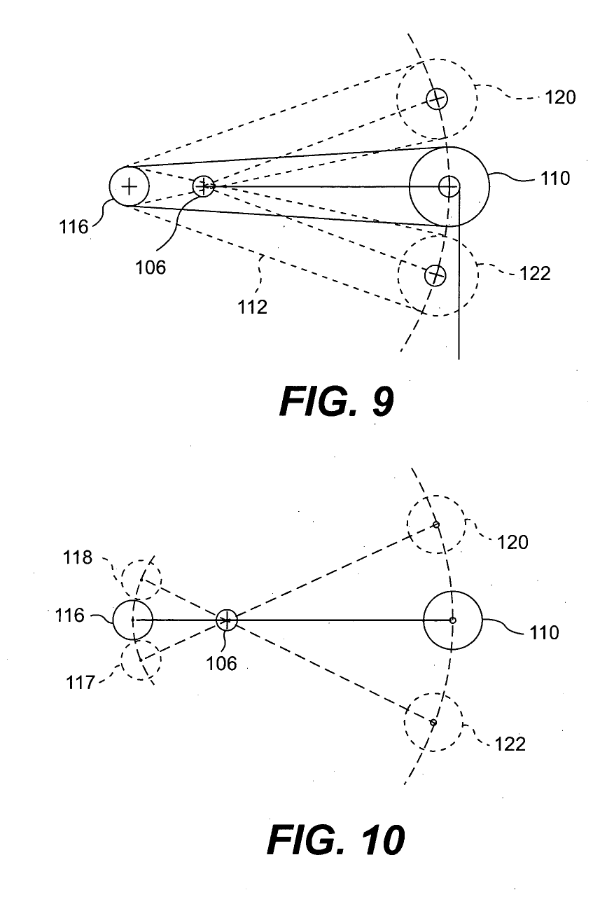

As also shown in FIG. 6, the rear wheel 98 is rotationally connected on the swing arm 100 by a bearing 108 on an axle 102. The swing arm 100 is pivotally connected to the frame 80 by a bearing 104 on an axle 106. With this construction, the swing arm 100 may pivot relative to the frame 80 so that the vehicle's suspension can absorb forces encountered during operation. This phenomenon is illustrated in FIG. 9, which is described below. It should be noted, however, that with this construction, although the two sprockets 88 and 96 are coplanar, the center distance between the sprockets 88, 96 changes as the swing arm 100 pivots about the axle 106.

It is noted that the specific vehicle layout provided in FIG. 6 (and in remaining figures appended hereto) is exemplary and illustrative only. As would be appreciated by those skilled in the art, other configurations may be employed without deviating from the scope of the present invention. For example, while the rubber mounts 84 are shown, a greater or fewer number may be employed to secure the engine and transmission assembly 82 to the frame. Also, the engine and transmission assembly 82 need not be such that the engine and transmission are an integral assembly. Instead, the transmission may be separate from the engine. Other variations that fall within the scope of the invention are too numerous to list, but would be appreciated by those skilled in the art.

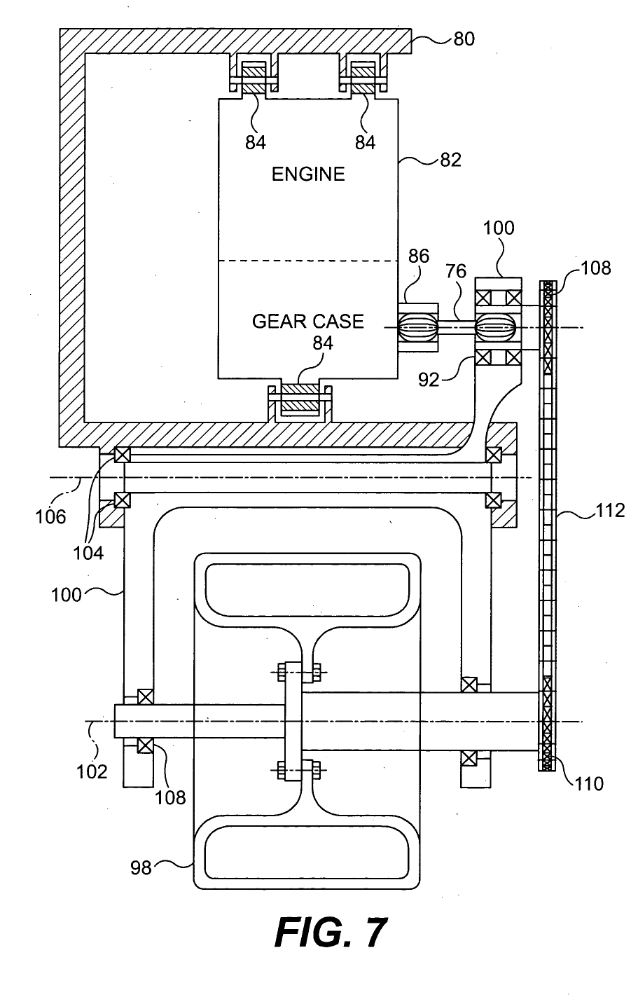

FIG. 7 illustrates a slightly different vehicle layout from the one presented by FIG. 6. In this embodiment, a portion of the swing arm 100 extends forwardly of the axle 106. The drive sprocket 108 in this embodiment is supported by the forward portion of the swing arm 100, not by the frame 80, as shown in FIG. 6 and described with respect to the previous embodiment. Because the drive sprocket 108 moves with the swing arm 100, the distance between the drive sprocket 108 and the drive sprocket 96 remain constant, regardless of the amount of displacement of the swing arm 100. This relationship is discussed in connection with FIG. 10, below.

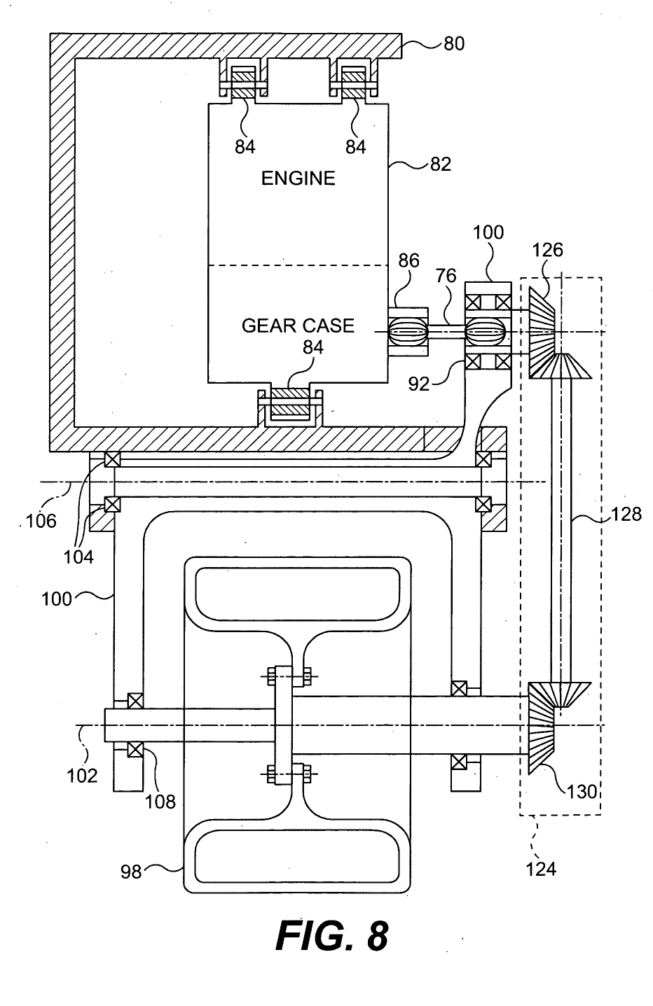

A drive shaft arrangement 124 is presented in FIG. 8. This embodiment is similar to the embodiment illustrated in FIG. 7. As illustrated in FIG. 8, a portion of the swing arm 100 extends forward of the drive axle 106. As in the previous embodiment, the power output member 86 is rotatably connected to the engine and the transmission assembly 82. The female portion of the power output member 82 accepts one end of the double spline male member connector 76. The other end of the double spline male member connector 76 is disposed within the female portion of a drive gear 126, which is journaled in the bearing 92 in the swing arm. The drive gear 126 operatively connects to a drive shaft 128 that extends to a driven gear 130, which is operatively connected to the rear wheel 98. Power generated by the engine and transmission assembly 82 is conveyed via the drive shaft 128 to the rear wheel 98 through operation of the drive gear 126 and the driven gear 130. The positioning of the drive gear 126 and the driven gear 130 on the swing arm 100 establish a constant distance therebetween that permits the use of a drive shaft 128, unlike the embodiment shown in FIG. 6.

FIG. 9 is a schematic illustration of the type of suspension shown in FIG. 6. The pivot axis 106 is not connected to the pivot axis of the front sprocket 116, which is rotationally mounted on the frame 80. In this geometric configuration, pivoting of the swing arm alters the linear distance between the front sprocket 116 and the rear sprocket 110. As a result, the chain 112 is subjected to varying degrees of tension as the rear sprocket 110 moves between its upper position 120 and its lower position 122, which defines the maximum travel limits for the illustrated suspension. To some degree, the chain 112 stretches as the suspension pivots between the upper and lower positions 120, 122.

FIG. 10 shows the suspension effect on the position of both front 116 and rear 110 sprockets according to movements of the suspensions illustrated in FIGS. 7 and 8. The suspension's pivot axis 106 remains at the same location as in FIG. 9.

However, here, since the front sprocket 116 is rotatively connected to the swing arm, the front sprocket 116 moves between an upper position 118 and a lower position 117. FIG. 10 also shows the rear sprocket 110 upper position 120 and lower position 122. Since the front sprocket 116 and the rear sprocket 110 both pivot about the pivot point 106, the chain length remains constant regardless of the swing arm position.

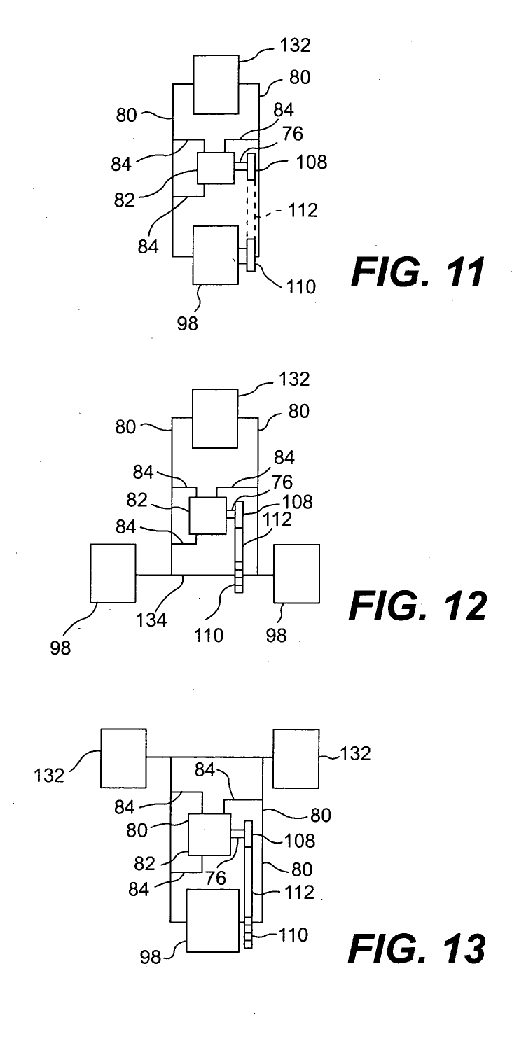

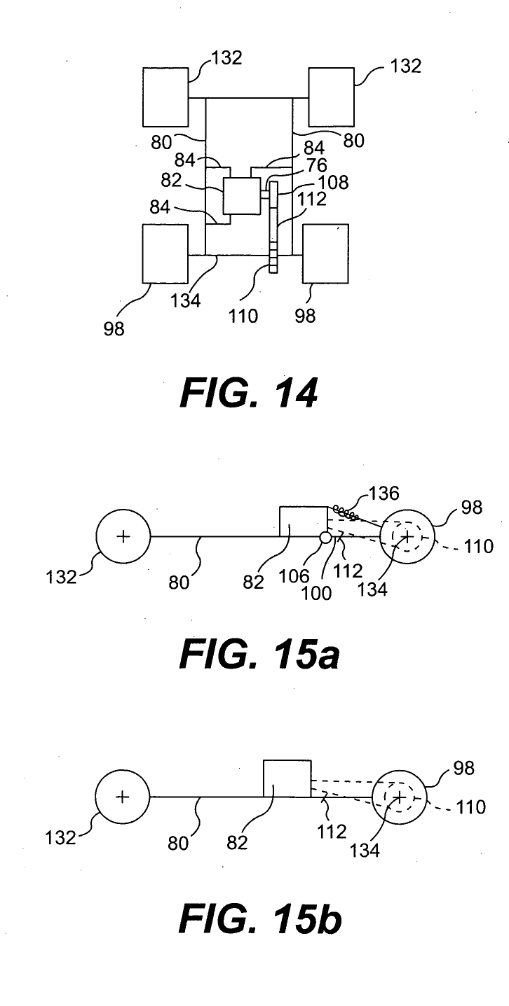

Several embodiments of a vehicle incorporating the embodiments of the present invention are illustrated in FIGS. 11-14. There are three vehicles preferably contemplated to incorporate the present invention: (1) the two-wheeled vehicle depicted in FIG. 11, (2) the three-wheeled vehicle shown in FIG. 13, and (3) the four-wheeled vehicle illustrated in FIG. 14. Despite this, as would be appreciated by those skilled in the art, the present invention may be incorporated into any suitable vehicle type, such as the three-wheeled vehicle shown in FIG. 12, and is not limited only to these three preferred vehicles.

A schematic top view of a two wheeled vehicle with a suspension of the type shown in FIG. 7 is shown in FIG. 11. The front wheel 132 and the rear wheel 98 are connected to the frame 80. Rubber mounts 84 connect the engine and transmission assembly 82 to the frame 80. The male type junction part 76 links the engine 82 to the drive sprocket 108 that transfers power via the chain 112 to the driven sprocket 110. The driven sprocket 110 applies the transferred power to the rear wheel 98.

A schematic top view of a three wheeled vehicle, with one wheel in front, is shown in FIG. 12. The front wheel 132 and the rear wheels 98 are connected to the frame 80. Rubber mounts 84 connect the engine and transmission assembly 82 to the frame 80. The male type junction part 76 links the engine 82 to the drive sprocket 108 that transfers power via the chain 112 to the driven sprocket 110. The driven sprocket 110 applies movement to the rear axle 134 on which rear wheels 98 are disposed.

A schematic top view of a three wheeled vehicle, with two wheels in front, is shown in FIG. 13. The front wheels 132 and the rear wheel 98 are connected to the frame 80. Rubber mounts 84 connect the engine and transmission assembly 82 on the frame 80. The male type junction part 76 links the engine 82 to the drive sprocket 108 that transfers power using the chain 112 to the driven sprocket 110. The driven sprocket 110 transfers power to the rear wheel 98.

A schematic top view of a four wheeled vehicle, such as an all terrain vehicle (“ATV”), with two wheels in front and two wheels at the rear, is shown in FIG. 14. The front wheels 132 and the rear wheels 98 are connected to the frame 80. Rubber mounts 84 connect the engine and transmission assembly 82 on the frame 80. The male type junction part 76 links the engine 82 to the drive sprocket 108 that transfers power via the chain 112 to the driven sprocket 110. The driven sprocket 110 rotates the rear axle 134, transferring power to the rear wheels 98.

A schematic side view of a vehicle having a suspension is shown in FIG. 15a. The front wheel 132 and the rear wheel 98 are connected to the frame 80. The engine 82 transfers power to the rear wheel 98 via a chain 112. A suspension pivot 106 allows movement of swing arm 100 with respect to the spring and damper assembly 136. FIG. 15b presents a vehicle layout without a suspension. As would be understood by those skilled in the art, a vehicle without a suspension system is simpler than a vehicle with a suspension in many ways. With respect to the present invention, a vehicle without a suspension system presents fewer moving variables that may impact the transfer of power from the engine and transmission assembly 82 to one or more of the vehicle's wheels 98.

In each of the vehicle embodiments illustrated in FIGS. 11-14, power is transmitted from the engine and transmission assembly 82 to the rear wheel or wheels 98 via the chain 112. As would be recognized by those skilled in the art, the embodiments illustrated in FIGS. 6 and 7 are equally applicable to each of the vehicle types. Moreover, as also would be appreciated by those skilled in the art, the embodiment illustrated in FIG. 8, with the drive shaft 128, could be incorporated in the vehicle instead.

As discussed above, it is noted that the engine and transmission assembly 82 is intended to encompass an engine and its associated transmission. However, as part of the present invention, where applicable, an engine without a transmission could be substituted for the engine and transmission assembly 82 without deviating from the scope of the present invention. Moreover, the engine and transmission assembly need not be integrally formed as a single unit.

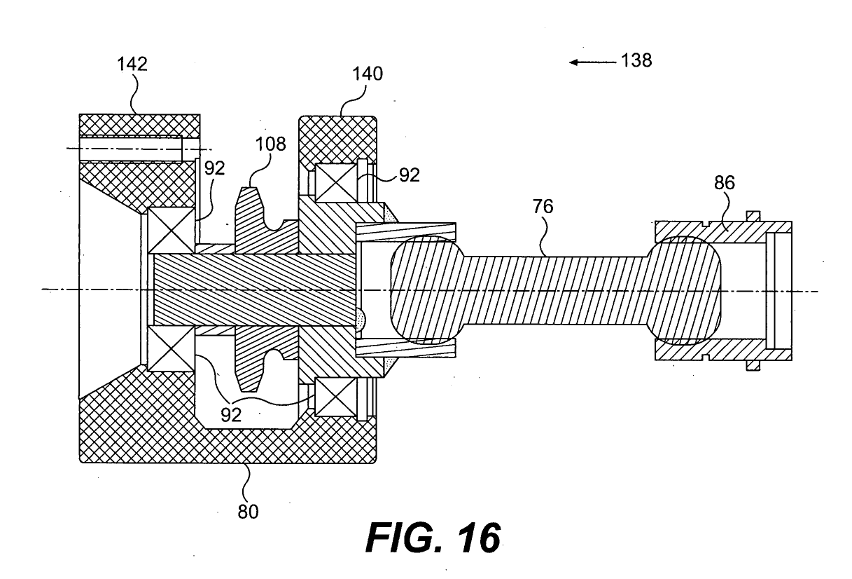

FIG. 16 presents a cross-sectional view of a preferred embodiment of the articulated drive sprocket system of the present invention. Arrow 138 indicates the outside of the vehicle. The drive sprocket 108 is held in double shear by the inner drive sprocket double shear support 140 and the outer drive sprocket double shear support 142. Both shear supports can be part of the frame 80 or of the swing arm 100. In the embodiment illustrated, the supports 140, 142 are manufactured as a part of the frame 80, as indicated.

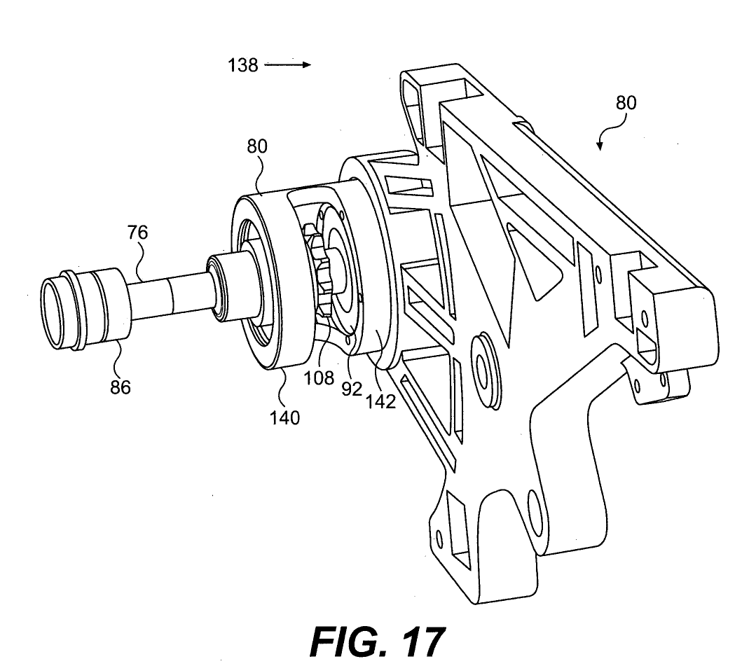

FIG. 17 provides a perspective of the preferred embodiment of the articulated drive sprocket system of the present invention, illustrated in cross-section in FIG. 16. The perspective illustration is taken from the rear end of the frame 80, the exterior of the vehicle being indicated at the right-hand side of the view by the arrow 138.

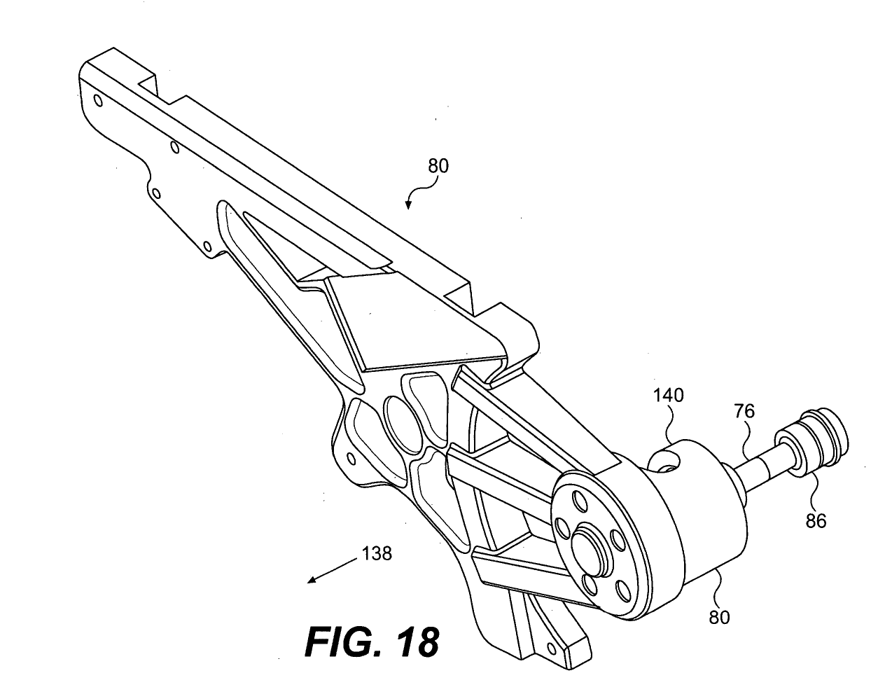

To provide further information about the preferred embodiment of the invention, FIG. 18 is a perspective view of the system illustrated in FIGS. 16 and 17. Here, the view is taken from the front end of the frame member 80 and shows the side that faces the exterior of the vehicle. Again, the arrow 138 provides a reference direction that points to the exterior of the vehicle.

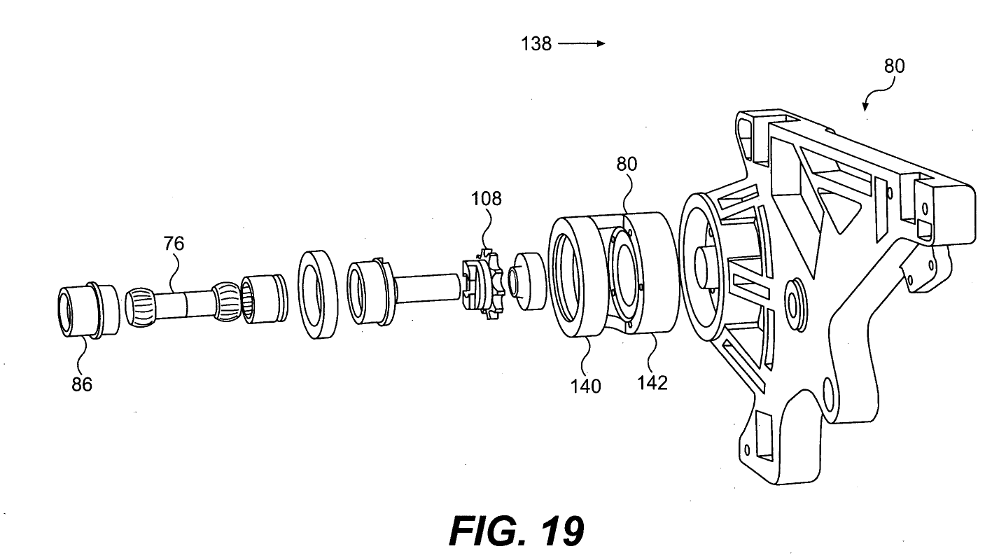

FIG. 19 is an exploded perspective view of the articulated drive sprocket shown in FIG. 16. The various components of the system are illustrated for explanatory purposes. This figure, like FIG. 17, illustrates the system from the rear of the frame 80.

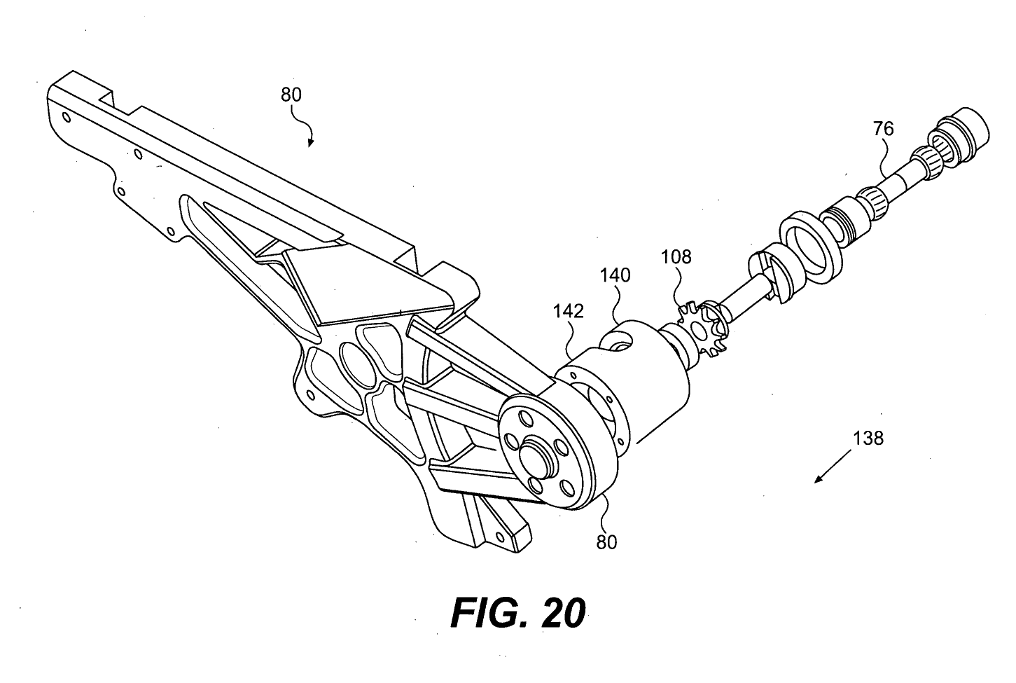

FIG. 20 also is an exploded perspective illustration of the articulated drive sprocket shown in FIG. 16. Like FIG. 18, FIG. 20 illustrates one of the preferred embodiments of the invention from the front of the frame member 80.

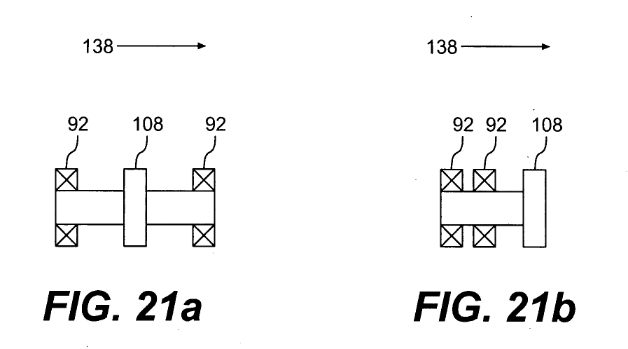

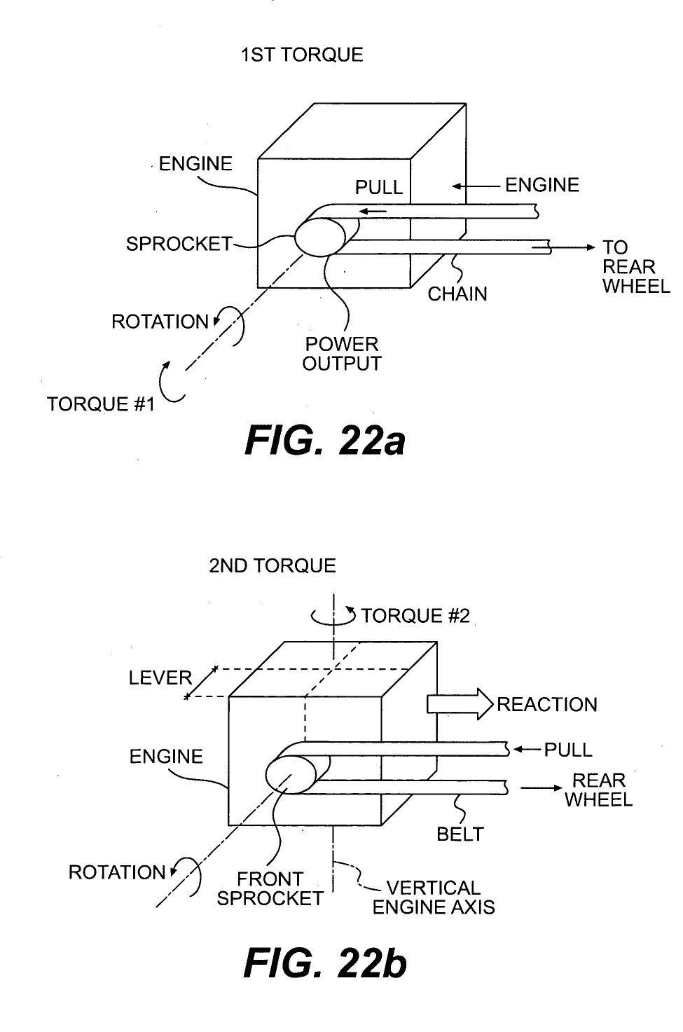

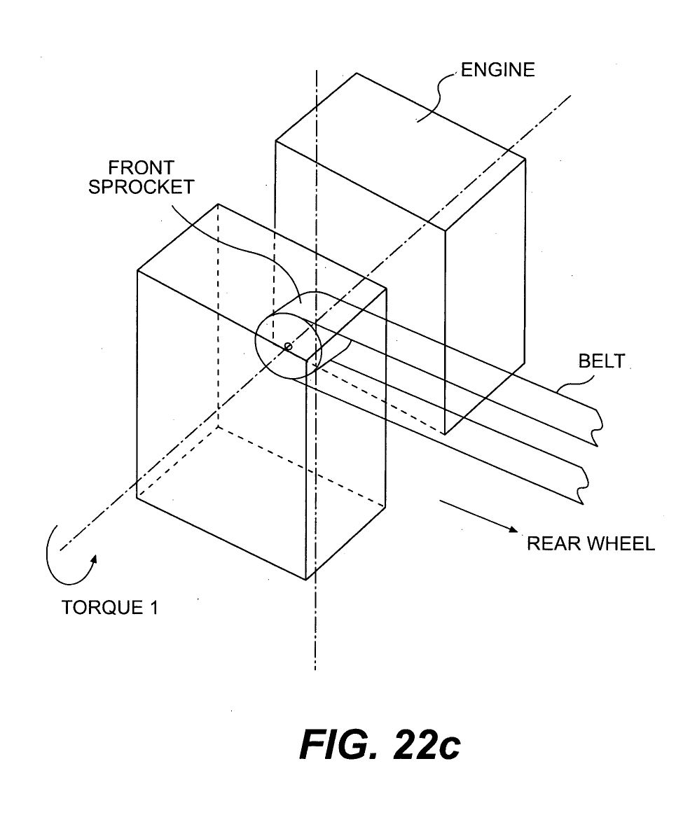

As indicated above, the present invention includes a double shear drive sprocket arrangement as opposed to a single shear drive sprocket arrangement. To facilitate an understanding of the differences between these two constructions, FIG. 21a and 21b are provided. It should be noted that, while a double shear drive sprocket arrangement is preferred, a single shear drive sprocket arrangement or any alternate of either of these arrangements may be employed without departing from the scope of the present invention.

The double shear drive sprocket arrangement illustrated in FIG. 21b offers some advantages over the single shear drive sprocket arrangement shown in FIG. 21a. While the single shear arrangement may be considered the more simple arrangement, torsional stresses imposed on the system are born by the side of the arrangement adjacent to the drive sprocket 108 that is closest to the engine and transmission assembly 82. In the single shear arrangement, to compensate for the concentration of stress on one side, the shaft must be enlarged in diameter by comparison with the double shear embodiment. Understandably, a larger diameter shaft has two distinct disadvantages, among others. First, a larger shaft is heavier in weight, which adds unnecessarily to the overall weight of the system and the vehicle on which it is installed. Second, the larger size of the shaft increases the manufacturing cost of the system, which increases unnecessarily the cost of the vehicle on which the system is installed.

As shown in FIG. 21b, the bearings 92 are located on the side of the drive sprocket 108 that lies adjacent to the interior of the vehicle. While bearings 92 are preferred, other supports such as bushings may be employed. This differs from the single shear arrangement where the bearings 92 are positioned on either side of the drive sprocket 108, as shown in FIG. 21a.

One advantage of the double shear drive sprocket arrangement preferred for the invention is that the drive sprocket 108 may be positioned on the interior side of frame 80. Accordingly, the drive chain 112 or belt 92 may be positioned toward the interior of the vehicle. This differs from the prior art where the drive sprocket 108 is typically located on the exterior side of the frame 80. This positioning is such that a housing does not need to be included to cover the chain 112 or belt 94. The frame 80 itself acts as a barrier to prevent the chain 112 or belt 94 from being touched by the operator during operation of the vehicle. Other advantages of this construction also may be apparent to those skilled in the art, but they are not enumerated here.

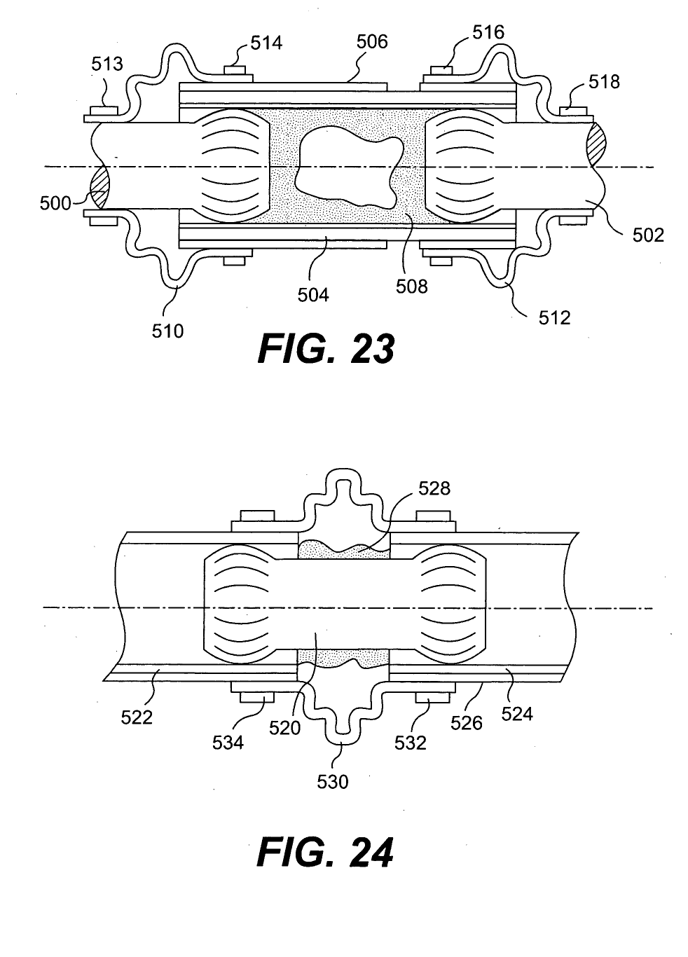

Reference will now be made to FIGS. 23 and 24. These two figures present detailed partial cross-sectional views of alternative preferred embodiments of the spline articulation of the present invention. FIG. 23 presents a detailed view of a preferred construction for a spline male articulation. FIG. 24 provides the details of a preferred spline female articulation. Both embodiments are discussed below. Both constructions include specific components and features, which help to reduce the noise generated by the spline articulations.

As shown in FIG. 23, the first shaft male 500 is connected to a second shaft 502 via a female connector 504 having internal splines. The female connector 504 preferably has a rubber coating 506, or a vibration damper material coating, to reduce vibrations. Grease 508 can be added internally to lubricate and add viscous vibration damping between the two metallic junctions. Rubber junctions 510 and 512 prevent the lubricant from leaking out of the joint while, at the same time, adding a damping effect between all the parts 500, 502 and 504. Clamps 513, 514, 516 and 518 are provided to secure the rubber junctions 510 and 512 to the shafts 500, 502 and the female connector 504.

FIG. 24 also presents an arrangement of the spline articulation that minimalizes noise generation. In this embodiment, a male connector 520 is disposed between two female shafts 522 and 524. The same rubber coating 526 may be used on each female shaft 522, 524. Viscous lubricant 528 may be included between the parts for the same purpose. A rubber junction 530 held by clamps 532 and 534 is also included in this embodiment.

The foregoing description is included to illustrate the operation of the preferred embodiment and is not meant to limit the scope of the invention. To the contrary, those skilled in the art should appreciate that varieties may be constructed and employed without departing from the scope of the invention, aspects of which are recited by the claims appended hereto.

What is claimed is:

1. A vehicle, comprising:
a. a frame;
b. an engine resiliently attached to the frame, generating power;
c. a power output member operatively connected to the engine;
d. at least one front wheel attached to the frame;
e. at least one rear wheel attached the frame;
f. a handle bar operatively connected to the frame, permitting steering of at least one of the front and rear wheels;
g. a straddle seat supported by the frame;
h. a power transmitting device operatively connected between the power output member and at least one of the front and rear wheels to transmit the power thereto from the engine; and
i. a link operatively coupled between the power output member and the power transmitting device, the link transmitting the power from the power output member to the power transmitting device such that at least one of angular or axial misalignment between the power output member and the power transmitting device is tolerated.

2. The vehicle of claim 1, wherein the engine is resiliently attached to the frame by rubber mounts.

3. The vehicle of claim 2, wherein the power transmitting device is selected from a group comprising a belt, a chain and a drive shaft.

4. The vehicle of claim 2, wherein the link is selected from a group comprising a crown spline, a universal joint, a spring shaped metallic member and a rubber member.

5. The vehicle of claim 2, further comprising a drive member disposed on the frame, operatively connecting the link to the power transmitting device, wherein the drive member resists translational movement relative to the frame.

6. The vehicle of claim 5, wherein the drive member is supported in double shear on the frame.

7. The vehicle of claim 2, further comprising a swing arm pivotally connected to the frame, wherein the swing arm supports at least one of the front and rear wheels.

8. The vehicle of claim 7, further comprising a drive member disposed on the swing arm, operatively connecting the link to the power transmitting device, wherein the drive member resists translational movement relative to the swing arm.

9. A vehicle, comprising:
a. a frame;
b. an engine resiliently attached to the frame, generating power;
c. a power output member operatively connected to the engine;
d. at least one front wheel attached to the frame;
e. at least one rear wheel attached to the frame;
f. a handle bar operatively connected to the frame, permitting steering of at least one of the front and rear wheels;
g. a straddle seat supported by the frame;
h. a power transmitting device operatively connected between the power output member and at least one of the front and rear wheels to transmit the power thereto from the engine; and
i. means for accommodating non rotational movement of the power transmitting device with respect to the output member and for transmitting rotational movement from the output member to the power transmitting device.

10. The vehicle of claim 9, wherein the engine is attached to the frame via means for reducing vibrational transfer between the engine and the frame.

11. The vehicle of claim 10, wherein the power transmitting device is selected from a group comprising a belt, a chain and a drive shaft.

12. The vehicle of claim 9, further comprising a drive member disposed on the frame, operatively connecting the power output member to the power transmitting device, wherein the drive member resists translational movement relative to the frame.

13. The vehicle of claim 9, further comprising:
a drive member operatively connecting the power output member to the power transmitting device; and
a swing arm pivotally connected to the frame supporting at least one of the front and rear wheels,
wherein the drive member resists translational movement with respect to the swing arm.

14. A vehicle, comprising:
a. a frame;
b. an engine resiliently mounted to the frame allowing relative movement of the engine with respect to the frame and attenuating transmission of engine vibrations to the frame, the engine having a power output member;
c. a straddle seat supported by the frame;
d. at least one front wheel connected to the frame;
e. at least one rear wheel connected to the frame;
f. a handle bar operatively connected to the frame, permitting steering of at least one of the front and rear wheels;
g. a drive member rotatably mounted to the frame, being constructed and arranged to receive power from the power output member; and
h. a shaft having a first end and a second end, the first end being connected to the power output member, the second end being connected to the drive member, wherein the shaft accommodates non rotational movement of the output member with respect to the drive member while transmitting rotational movement of the output member from the drive member.
